(19) United States
(12) Patent Application Publication
(10) Pub. No.: US 2021/0362162 A1
(43) Pub. Date: Nov. 25, 2021

(54) Thermal Cycler for DNA Amplification and Real-Time Detection

(71) Applicant: Michael Rosenblum, Hoboken, NJ (US)

(72) Inventor: Michael Rosenblum, Hoboken, NJ (US)

(21) Appl. No.: 16/879,727

(22) Filed: May 20, 2020

(51) Int. Cl. B01L 7/00; B01L 3/00

(52) U.S. Cl. CPC B01L 7/52; B01L 2300/1822; B01L 2300/1844; B01L 3/50853

(57) ABSTRACT

A thermal cycler for DNA amplification and real-time detection comprises a sample block with a position for a sample tube containing fluorescent molecules; an LED light for excitation of the fluorescent molecules at a predetermined wavelength; a filter that passes light at the predetermined wavelength to allow excitation of the fluorescent molecules; and a housing for the sample block, the LED light, and the filter that allows visualization of the fluorescent signal. The device may utilize a smart phone with a camera or the naked eye to detect fluorescence.

### RELATED APPLICATIONS

This application claims the benefit of the filing date of U.S. Patent Application No. 62/850,080, filed May 20, 2019, which is incorporated herein by reference in its entirety.

### BACKGROUND OF THE INVENTION

The present invention generally relates to thermal cycler devices for PCR (Polymerase Chain Reaction) and more specifically to a thermal cycler for DNA amplification and real-time detection.

The use of thermal cycler devices for the PCR process to make copies of DNA molecules is well known. “Real Time” thermal cyclers are also commonly used devices that combine a thermal cycler device with optical systems and computer electronics in order to monitor the process of the DNA amplification.

Real time thermal cyclers commonly use a light source and optical filters to produce specific light wavelengths to provide excitation of fluorescent molecules that are binding or interacting with DNA in a sample tube. These devices also incorporate photodiode detectors to detect and measure the level of fluorescence produced. During a PCR reaction, the amount of DNA increases and the interacting fluorescent molecules will produce increased fluorescence proportionally to the amount of DNA. An internal computer system and software (or external computer and software) processes information from the photodiode detectors to create graphical representations of the level of fluorescence increasing during each cycle of the PCR.

Drawbacks to the existing Real Time Thermal Cyclers include:

Size. These are large heavy machines that are difficult to move and therefore difficult to bring into the field for convenient testing.

Cost. Real Time Thermal cyclers cost in the range of $15,000 to $25,000. This is due to complex optical systems, photodiode detectors and microprocessors and related computer peripheries.

Complexity: Programming and interpreting the data is complicated.

Current Real Time Thermal Cyclers are designed in a manner that the sample tubes are contained within a heating/cooling block, covered by a heated lid to prevent evaporation and condensation, and with optical components such as light sources and photo diode detectors surrounding the sample tubes. This makes visible access to the sample tubes impossible.

It would be desirable to have a real time thermal cycler device for DNA amplification and detection that is small in size, simple to use, offers the basic advantages of fluorescent detection of amplified DNA samples by eye (or mobile phone camera), and is available at a price point significantly lower than currently available real time thermal cycler devices.

### SUMMARY OF THE INVENTION

In one aspect of the present invention, a device comprises a sample block with a position for a sample tube containing fluorescent molecules; an LED light for excitation of the fluorescent molecules at a predetermined wavelength; a filter that passes light at the predetermined wavelength to allow excitation of the fluorescent molecules; and a housing for the sample block, the LED light, and the filter that allows visualization of the fluorescent signal.

In another aspect of the present invention, a device comprises a position for a sample tube containing fluorescent molecules, DNA, or PCR reagents; an LED light for excitation of the fluorescent molecules at a predetermined wavelength; an amber filter that passes light at the predetermined wavelength to allow excitation of the fluorescent molecules, the filter allowing visualization of a green fluorescent signal; a housing for the sample block, the LED light, and the filter that allows visualization of the fluorescent signal, the housing adapted to hold a camera of a smart phone in an appropriate place to photograph the fluorescent signal; a heat sink that cools the sample block; a fan that cools the fluorescent molecules; a metal heat conducting lid for the sample tube to prevent condensation inside the sample tube; and a heat element for the lid to contact the top of the sample tube and prevent condensation.

In yet another aspect of the present invention, a device comprises LED lights and filters for excitation of fluorescent molecules; a sample block with a position for a sample tube containing the fluorescent molecules; and a housing for the sample block, the LED lights, and the filters that allows visualization by naked eye of a fluorescence coming from the sample tube.

### BRIEF DESCRIPTION OF THE DRAWINGS

FIG. 1 depicts an embodiment of a device for real time DNA amplification according to the present invention; and

FIG. 2 depicts an embodiment of a process for real time DNA amplification according to the present invention.

### DETAILED DESCRIPTION

The preferred embodiment and other embodiments, which can be used in industry and include the best mode now known of carrying out the invention, are hereby described in detail with reference to the drawings. Further embodiments, features and advantages will become apparent from the ensuing description, or may be learned without undue experimentation. The figures are not necessarily drawn to scale, except where otherwise indicated. The following description of embodiments, even if phrased in terms of “the invention” or what the embodiment “is,” is not to be taken in a limiting sense, but describes the manner and process of making and using the invention. The coverage of this patent will be described in the claims. The order in which steps are listed in the claims does not necessarily indicate that the steps must be performed in that order.

The present invention is related to real time thermal cycler devices for DNA amplification by PCR (Polymerase Chain Reaction) and detection by fluorescence. Embodiments may provide a novel and economical real time thermal cycler device and method for DNA amplification and detection by the naked eye. The device may utilize LED lights and filters for excitation of fluorescent molecules and allows visible detection of the fluorescence by the naked eye.

Embodiments of this invention may be useful for education, research, industrial testing and clinical laboratory scientists that want to detect and identify specific organisms or specific genes by targeted amplification of specific DNA (or other nucleic acid) sequences. Embodiments of this invention may provide and support viewing fluorophors in conjunction with a thermal cycler instrument and an instrument design to allow visual observation of the fluorescent samples in tubes.

Embodiments of the invention may provide a simplified and lower priced real time thermal cycler device to perform PCR reactions that can provide the basic advantages of more expensive real time thermal cycler devices: rapid amplification and detection of specific DNA targets.

Embodiments of a device having a sample block, position of tubes, excitation light source, and filters may allow visualization of fluorescence coming from the sample tubes by naked eye. Embodiments may allow connecting by wire or wirelessly (i.e. Bluetooth), a smart phone, or a tablet with camera to use the camera function as part of an app to capture images and measure levels of fluorescent signals at specific time intervals.

Embodiments of the invention may provide an improvement to the currently popular and available quantitative polymerase chain reaction (qPCR) instruments available on the market. Embodiments may lower the manufacturing and end user price, but still allow the major benefits of a qPCR instrument: specifically the positive detection of amplified DNA molecules.

Embodiments may utilize low cost LED lights, low cost filters (preferably made of translucent colored plastic), and may allow the user to directly visualize the fluorescent signal produced when DNA is substantially amplified.

Electronic components of an embodiment of the invention may include miniature computer components, such as small computer for running the software, connected to additional required circuit board(s) needed to control power to other components. Additional components may include Peltier chips for heating and cooling samples, fans, thermal probes, heating elements, or LED lights.

Embodiments may include a sample heating block, heated lid, instrument housing, and placement of the excitation light source and filters to allow visual access to the sample tubes and the combination of excitation wavelength with an amber filter allows the fluorescent signal to be easily seen by the naked eye, thus eliminating the need and usage of photodiode detectors and the associated microprocessor electronics.

Embodiments of the top of the instrument may be designed to allow connection and usage of a smart phone camera to capture images and monitor the level of fluorescence from the sample. The smart phone (or tablet device) may be used in cooperation with embodiments of the invention for capturing images/monitoring fluorescence. The combination maybe used for wireless (or wired) programming and control of a microprocessor. This wireless/wired connection to the polymerase chain reaction (PCR) instrument may also allow coordination of capturing fluorescent signal images with specific temperature cycle numbers.

Embodiments of the invention may work in the absence of photodiodes and complex microprocessor systems, color displays, and control panels. Embodiments may avoid the requirement for programming or processing signal information, but may allow a fluorescent signal from the sample tubes to be observed directly by the user with the naked eye

In an embodiment of the invention the excitation light could come from the top of the tube, and the viewing of the tube could be from the side. In another embodiment, the excitation light could come from the side, and the viewing of the fluorescence from the tube could be from the other side

In one embodiment of the invention the typical PCR sample tubes with caps can be replaced with microfluidic chips that hold the liquid samples and reagents, providing a large amount of viewing surface for seeing fluorescence (or no fluorescence).

In another embodiment of the invention an app (program) in the smart phone or tablet may be designed to connect to the device by wire or wirelessly to program the thermal cycling steps (temperature steps, dwell time, repeating steps). In another embodiment of the invention, a smart phone app may also use the camera as a detector of the fluorescent signal, to record at which cycle the fluorescent signal becomes stronger

In another embodiment of the invention a camera system of the smart phone may be used to detect the level of fluorescence as it increases with each cycle and to process this information to create a fluorescent curve graph (fluorescent level vs. time) similar to that of more complex real time thermal cyclers

In another embodiment of the invention the internal electronic controls may consist of an economical microprocessor board such as an.

In one embodiment, the LED lights, excitation and viewing filters can be replaced, to allow visual detection of different types of fluorophors that have different excitation and emission wavelengths.

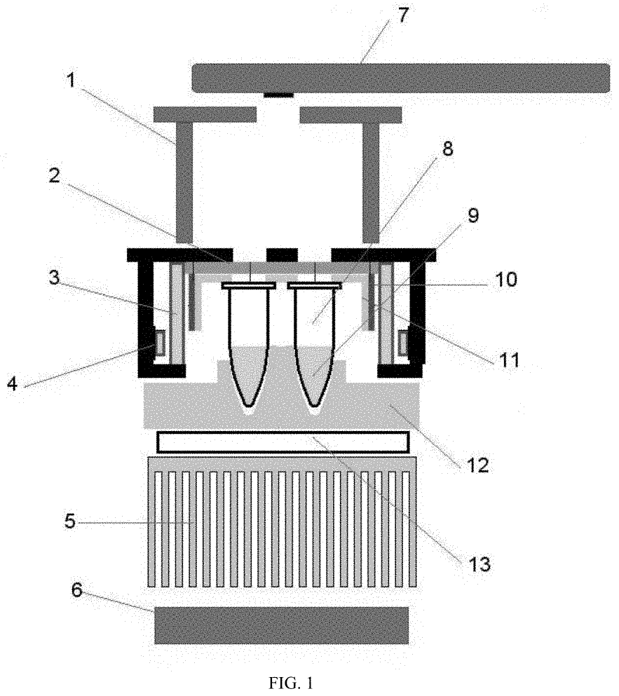

As depicted in the FIG. 1, an embodiment of a device may include a smart phone enclosure 1 for a smart phone camera 7. As depicted, the camera lens of a smart phone may be held in the appropriate place by the enclosure.

A DNA sample 9 may be retained in plastic sample tube vessels 8, which are themselves held in a metal sample block 12. A metal heat conducting lid 11 may cover the plastic sample tube vessels, and may conduct heat from a heating element 10. A Peltier chip 13 (a thermoelectric heater/cooler) may help heat and cool the samples. A heat sink 5 and a fan 6 may be used in conjunction with the Peltier chip for heating and cooling the sample block.

An LED light source 4 may provide a wavelength for excitation of fluorescent molecules bound to DNA. The appropriate wavelengths may be further refined using an excitation wavelength filter 3. An amber emission filter 2 may block blue light to allow clear visualization of a green fluorescent signal.

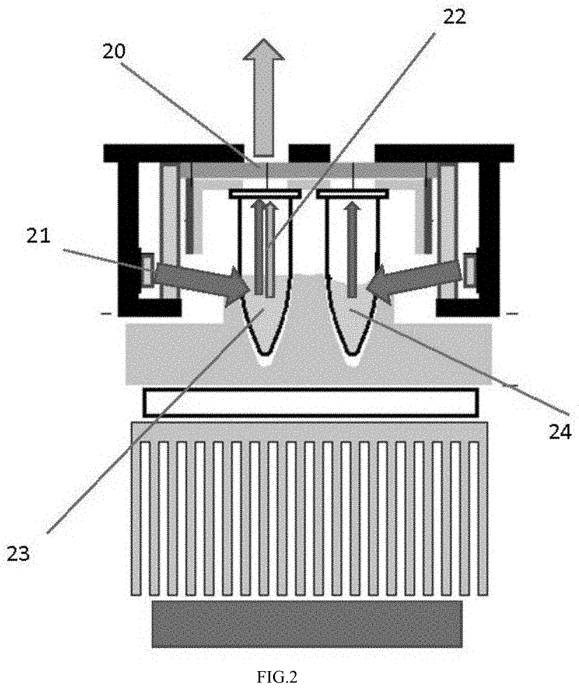

FIG. 2 depicts how an embodiment of the present invention may work. An embodiment of a process may utilize an amber emission filter in order to block blue light to allow clear visualization of green fluorescent signal (at 20). LED light and the emission filter provide a wavelength for excitation of fluorescent molecules bound to DNA (at 21). A Fluorescent signal mixed with blue excitation light (at 22) is passed up from the sample and through the amber emission filter.

As depicted on the left (at 23), a sample has positive amplification of DNA and presents a positive fluorescent signal. As depicted on the right (at 24), a sample with negative results has no DNA amplification and no fluorescent signal. The fluorescent signal may be detected with the naked eye, or by utilizing the camera of a smart phone to detect, record, or photograph the fluorescent signal.

I claim:

1. A device comprising:
a sample block with a position for a sample tube containing fluorescent molecules;
an LED light for excitation of the fluorescent molecules at a predetermined wavelength;
a filter that passes light at the predetermined wavelength to allow excitation of the fluorescent molecules; and
a housing for the sample block, the LED light, and the filter that allows visualization of the fluorescent signal.

2. The device of claim 1, wherein the sample tube further contains DNA.

3. The device of claim 1, wherein the sample tube further contains PCR reagents.

4. The device of claim 1, wherein the housing is further adapted to hold a camera in an appropriate place to photograph the fluorescent signal.

5. The device of claim 1, wherein the housing is further adapted to hold a camera of a smart phone in an appropriate place to photograph the fluorescent signal.

6. The device of claim 1, wherein the filter is an amber filter that allows visualization of a green fluorescent signal.

7. The device of claim 1, further comprising a heat sink that cools the sample block.

8. The device of claim 1, further comprising a fan that cools the sample block.

9. The device of claim 1, further comprising a Peltier thermoelectric heater/cooler that heats and cools the fluorescent molecules.

10. The device of claim 1, further comprising a metal heat conducting lid for the sample tube and a heat element for the lid.

11. The device of claim 1, further comprising a metal heat conducting lid and a heat element for the lid to contact the top of the sample tube and prevent condensation.

12. A device comprising:
a sample block with a position for a sample tube containing fluorescent molecules, DNA, or PCR reagents;
an LED light for excitation of the fluorescent molecules at a predetermined wavelength;
an amber filter that passes light at the predetermined wavelength to allow excitation of the fluorescent molecules, the filter allowing visualization of a green fluorescent signal;
a housing for the sample block, the LED light, and the filter that allows visualization of the fluorescent signal, the housing adapted to hold a camera of a smart phone in an appropriate place to photograph the fluorescent signal;
a heat sink that cools the sample block;
a fan that cools the fluorescent molecules;
a metal heat conducting lid for the sample tube to prevent condensation inside the sample tube; and
a heat element for the lid to contact the top of the sample tube and prevent condensation.

13. A device comprising:
LED lights and filters for excitation of fluorescent molecules;
a sample block with a position for a sample tube containing the fluorescent molecules; and
a housing for the sample block, the LED lights, and the filters that allows visualization by naked eye of a fluorescence coming from the sample tube.
